(19) United States
(12) Patent Application Publication
(10) Pub. No.: US 2018/0300033 A1
(43) Pub. Date: Oct. 18, 2018

(54) DISPLAY METHOD AND DISPLAY DEVICE

(71) Applicants: BOE TECHNOLOGY GROUP CO., LTD., Beijing (CN); CHONGQING BOE OPTOELECTRONICS TECHNOLOGY CO., LTD., Chongqing (CN)

(72) Inventors: Shuai CHEN, Beijing (CN); Zhi ZHANG, Beijing (CN); Shaoru LI, Beijing (CN); Hui Che LIN, Beijing (CN); Zhihui WANG, Beijing (CN); Siqing FU, Beijing (CN); Lisheng LIANG, Beijing (CN); Yuanbo ZHANG, Beijing (CN); Xin LIU, Beijing (CN)

(21) Appl. No.: 15/578,441

(22) PCT Filed: Mar. 30, 2017
(86) PCT No.: PCT/CN2017/078812

§ 371 Date: Nov. 30, 2017

(30) Foreign Application Priority Data
Jun. 6, 2016 (CN) 201610393099.5

(51) Int. Cl. G06F 3/0485; G06F 3/147; G06F 3/0354; G06F 3/0481

(52) U.S. Cl. CPC G06F 3/0485; G06F 3/0481; G06F 3/03548; G06F 3/147

(57) ABSTRACT

The present disclosure provides a display method and a display device. There is provided a display method for a display, wherein the display method comprises the following steps: detecting movement data of the display by a motion detection mechanism, wherein the movement data comprises at least a movement direction of the display; and changing a region of an object currently displayed by the display which is displayed on a display screen according to the movement data of the display.

### CROSS-REFERENCE TO RELATED APPLICATIONS

The present application is a U.S. National Stage under 35 U.S.C. § 371 of International Application No. PCT/CN2017/078812, filed on Mar. 30, 2017, designating the United States and claiming priority to and the benefit of Chinese Patent Application No. 201610393099.5, filed with the Chinese Patent Office on Jun. 6, 2016 and entitled “DISPLAY METHOD AND DISPLAY DEVICE”, which is hereby incorporated by reference in its entirety.

### TECHNICAL FIELD

The present disclosure relates to a display method and a display device.

### BACKGROUND

At present, cellphones and other electronic products with a display are more and more widely used in human life, especially a big-screen cellphone is particularly becoming more and more popular due to its better presentation effect of a picture. However, a picture or a webpage is sometimes too big so that a cellphone screen can not present the whole image entirely and can only present a part of the image. It is necessary to use a finger to slide the screen to browse other parts of the image.

### SUMMARY

According to one aspect, the present disclosure provides a display method for a display, the display method comprises the following steps:

detecting movement data of the display by a motion detection mechanism, wherein the movement data comprises at least a movement direction of the display;

changing a region of an object currently displayed by the display which is displayed on a display screen according to the movement data of the display.

According to another aspect, the present disclosure provides a display device for a display, which comprises:

a movement detection module for detecting movement data of the display by a motion detection mechanism, wherein the movement data comprises at least a movement direction of the display;

a display region adjustment module for changing a region of an object currently displayed by the display which is displayed on a display screen according to the movement data of the display.

### BRIEF DESCRIPTION OF THE DRAWINGS

FIG. 1 is a flow chart of a display method according to some embodiments of the present disclosure;

FIG. 2 is a schematic view of a case where a picture is too big according to some embodiments of the present disclosure;

FIG. 3 is a flow chart of a method according to some embodiments of the present disclosure;

FIG. 4A is a schematic view of a display object coordinate system and a display screen coordinate system according to some embodiments of the present disclosure;

FIG. 4B is a schematic view of a case where content displayed on a screen exceeds boundaries of a display object according to some embodiments of the present disclosure;

FIG. 4C is a schematic view of another case where content displayed on a screen exceeds boundaries of a display object of an embodiment according to the present disclosure;

FIG. 4D is a schematic view of display content adjustment when a display is moved according to some embodiments of the present disclosure;

FIG. 5 is a block diagram of a display device according to some embodiments of the present disclosure.

### DETAILED DESCRIPTION

In order to make technical problems to be solved by the present disclosure, technical solutions and advantages more clear, a detail description will be given in conjunction with drawings and specific embodiments.

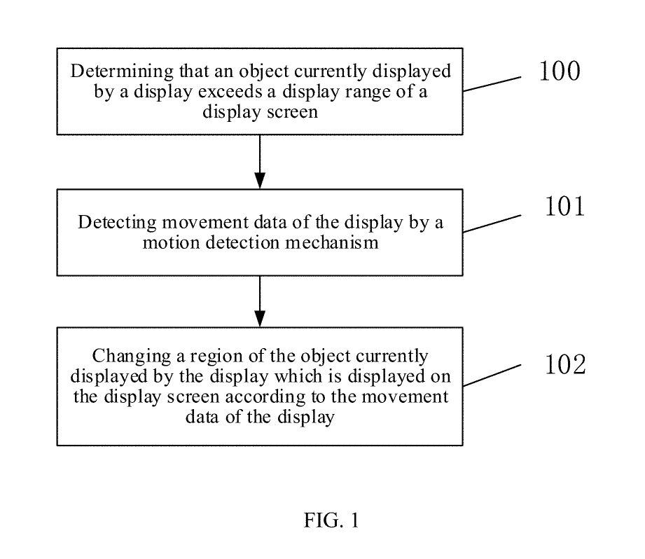

The present disclosure first provides a display method for a display, which comprises steps as shown in FIG. 1:

step 101: detecting movement data of the display by a motion detection mechanism, wherein the movement data comprises at least a movement direction of the display;

step 102: changing a region of an object currently displayed by the display which is displayed on a display screen according to the movement data of the display.

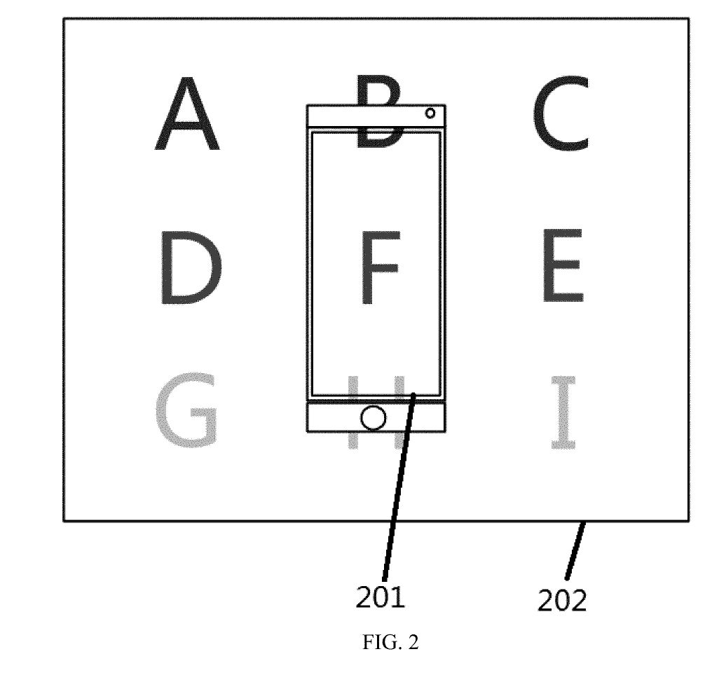

Sometimes, when a user uses a mobile terminal such as a cellphone, a tablet computer, he/she often encounters a case where he/she views a display object such as a picture and enlarges it. Sometimes, since the display range of the display object is too big, the screen cannot display it entirely, as shown in FIG. 2, a display screen 201 of the display can only display an “F” portion in a whole picture 202, and if other parts need to be displayed, it has to be done by sliding the screen with a finger or with the help of a hardware input apparatus such as a button. The display method provided by the present disclosure can detect movement data of the display and change the display region according to the movement data, such that when a user views a picture, he/she is only needed to move the display to view the part of the picture which is beyond the screen, thereby the user does not need to use his/her finger to slide the picture or use a button to adjust the picture, which facilitate the user browsing the picture.

In some embodiments of the present disclosure, the display is a display of a portable mobile apparatus such as a display of a cellphone, a display of a tablet computer, a display of a portable player, a display of a notebook computer. In some embodiments of the present disclosure, the step of changing the region of the object currently displayed by the display which is displayed on the display screen according to the movement data of the display comprises:

changing the region of the object currently displayed by the display which is displayed on the display screen, wherein a vector direction from the origin of the original display region to the origin of the new display region after the change being consistent with the movement direction indicated in the movement data of the display;

or changing the region of the object currently displayed by the display which is displayed on the display screen, wherein a vector direction from the origin of the original display region to the origin of the new display region after the change being reverse to the movement direction indicated in the movement data of the display;

In some embodiments of the present disclosure, the display object is a picture or text, etc.

In some embodiments of the present disclosure, still referring to FIG. 1, before the step of detecting the movement data of the display by the motion detection mechanism, it further comprises:

step 100: determining that the object currently displayed by the display exceeds a display range of the display screen.

In some embodiments of the present disclosure, before the step 100, it comprises the following steps:

detecting a display object opening operation;

or detecting a display object enlarging operation;

or detecting a display object reducing operation.

In some embodiments of the present disclosure, the step of determining that the object currently displayed by the display exceeds the display range of the display screen comprises:

obtaining size information of the object currently displayed by the display;

comparing the size information with size information of the display screen, and determining that the length of the object currently displayed by the display exceeds the length of the display screen or the width of the object currently displayed by the display exceeds the width of the display screen. Before displaying the display object, the size of the display object is judged, it is judged whether the picture is too big. If a display screen cannot present the display object entirely and can only display a part of the display object, the method enters step 101.

In some embodiments of the present disclosure, the size information of the display object may be acquired from codes of the display object. For example, when the display object is a picture, the size information of the picture may be acquired from codes of the picture. After the display object is enlarged or reduced, codes of the display object are changed. At this time, the size information of the display object is acquired again.

In some embodiments of the present disclosure, before the step of changing the region of the object currently displayed by the display which is displayed on the display screen according to the movement data of the display, the method further comprises:

establishing a corresponding relationship between a coordinate system of the object currently displayed by the display and a coordinate system of the display screen.

For example, a coordinate origin is set on the display screen, and coordinates are established according to this set coordinate origin; at the same time, another coordinate origin is set on the display object, and coordinates of the display object are set according to this coordinate origin.

In some embodiments of the present disclosure, the step of changing the region of the object currently displayed by the display which is displayed on the display screen according to the movement data of the display comprises:

computing a new position of a set point on the display screen in the display object coordinate system according to the movement data of the display;

adjusting the region of the object currently displayed by the display which is displayed on the display screen so that the set point on the display screen reaches the new position, and displaying display information of a display object region corresponding to the new position.

In other embodiments of the present disclosure, it is possible to set one fixed point on the display screen and on the display object respectively. For example, the midpoint of the display screen is set as the screen fixed point, and the midpoint of the display object is set as the display object fixed point. After it is determined that movement in a first direction occurs to the display according to the movement data of the display, the display object fixed point is moved in the first direction relative to the screen fixed point.

In some embodiments of the present disclosure, the step of computing the new position of the set point on the display screen in the display object coordinate system according to the movement data of the display comprises:

computing the movement direction of the display, and computing the position change direction of the set point on the display screen in the display object coordinate system according to the movement direction of the display;

adding a set step to the original position of the set point on the display screen in the display object coordinate system in the change direction to obtain the new position of the set point in the display object coordinate system.

In some embodiments of the present disclosure, the step of changing the region of the object currently displayed by the display which is displayed on the display screen according to the movement data of the display further comprises:

when content displayed on the display screen exceeds boundaries of the object currently displayed by the display, employing a set pattern display for display content of boundaries of the object currently displayed by the display.

In some other embodiments of the present disclosure, the step of changing the region of the object currently displayed by the display which is displayed on the display screen according to the movement data of the display further comprises:

when content displayed on the display screen exceeds boundaries of the object currently displayed by the display, no longer changing the region of the object currently displayed by the display which is displayed on the display screen.

In some embodiments of the present disclosure, the motion detection mechanism includes one or more of a gyroscope, a gravity sensor, an acceleration sensor, or a camera built in the display.

In some embodiments of the present disclosure, the movement direction of the display is determined by combining a speed sensor and a camera associated with the display. If the position of the set point on the display screen in the display object coordinate system is changed by a set step in a corresponding direction whenever movement of the display is detected, it is only necessary to obtain the movement direction of the display to achieve the change of the display region. If the position of the set point on the display screen in the display object coordinate system is changed by a corresponding step in a corresponding direction according to acceleration of movement of the display or distance of the movement of the display whenever the movement of the display is detected, it is also necessary to obtain speed or distance information of the movement of the display in addition to obtaining the movement direction of the display.

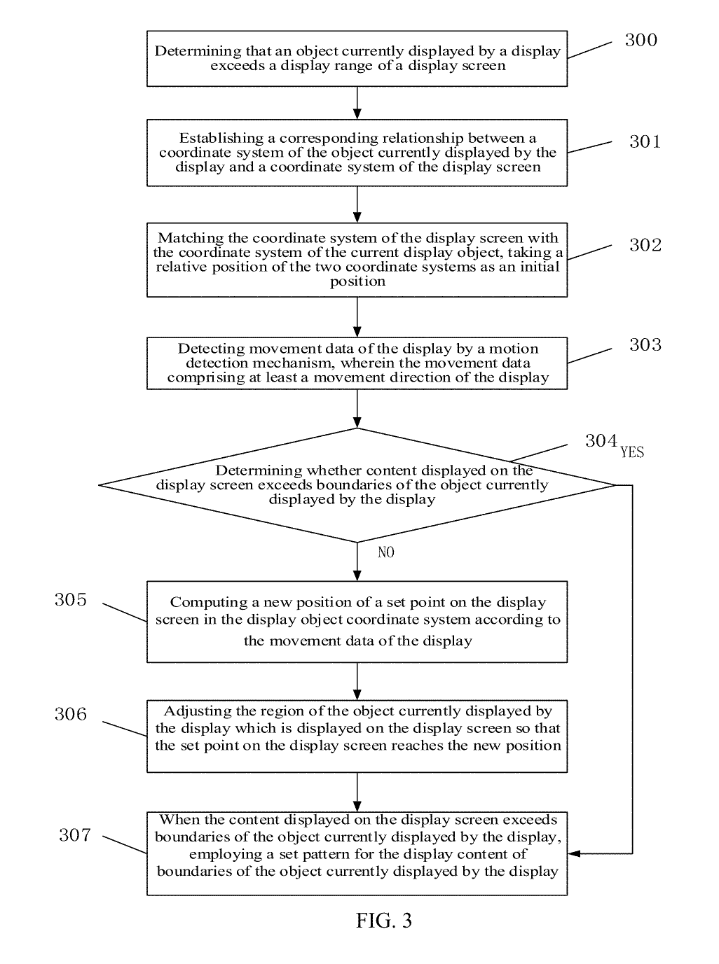

In some embodiments of the present disclosure, the method comprises steps as shown in FIG. 3:

step 300: determining that an object currently displayed by a display exceeds a display range of a display screen;

step 301: establishing a corresponding relationship between a coordinate system of the object currently displayed by the display and a coordinate system of the display screen;

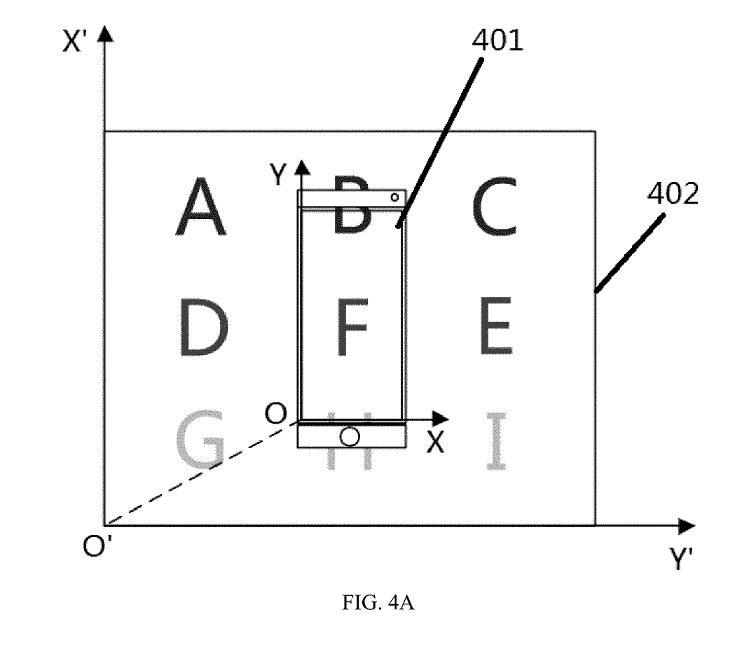

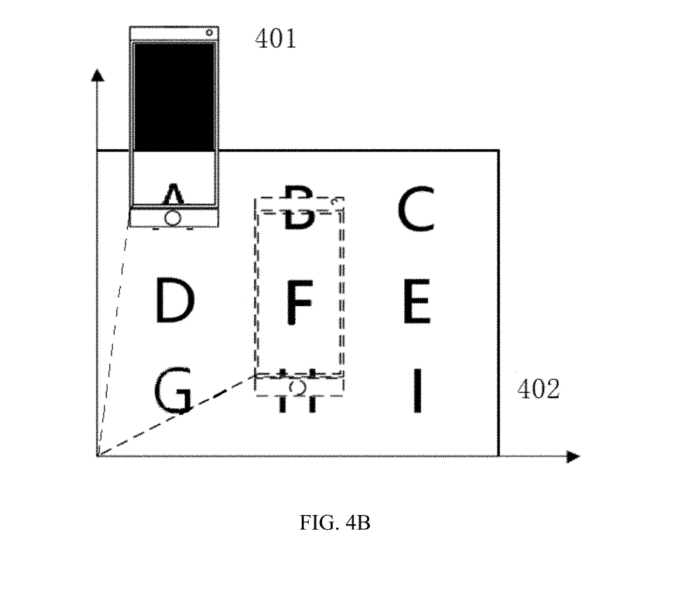

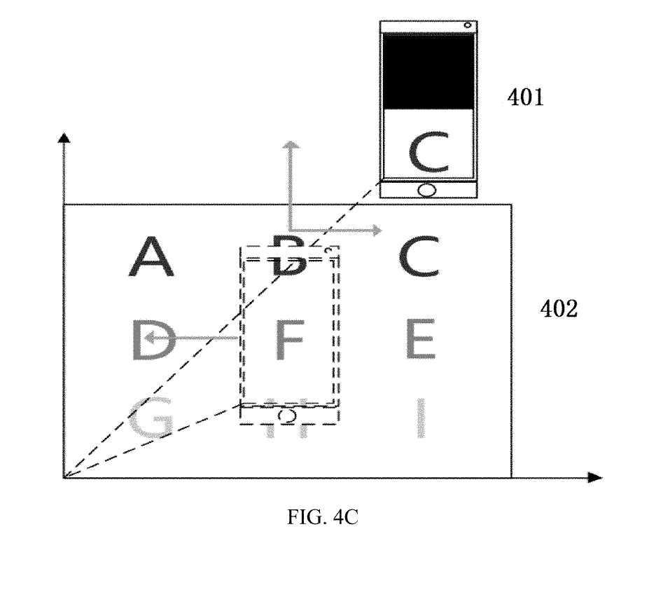

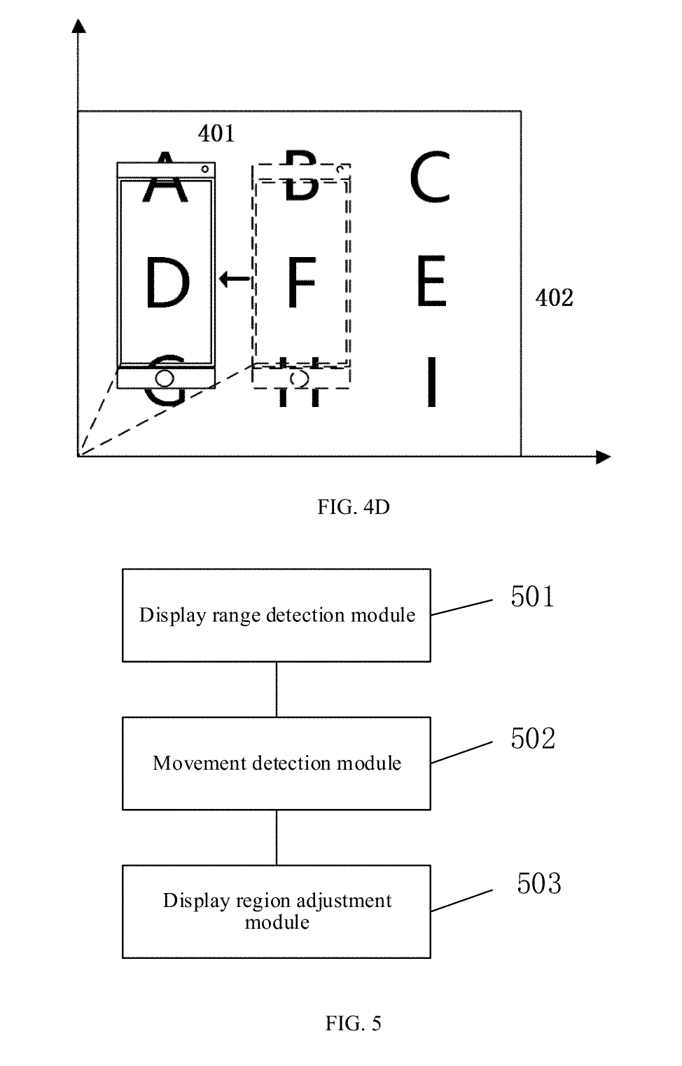

step 302: matching the coordinate system of the display screen with the coordinate system of the current display object, and taking a relative position of the two coordinate systems as an initial position; for example, as shown in FIG. 4A, the coordinate system of the display screen 401 is OXY, the coordinate system of the current display object 402 is O′X′Y′, and the relative position shown in FIG. 4A is used as the initial position;

step 303: detecting movement data of the display by a motion detection mechanism, wherein the movement data comprises at least a movement direction of the display; in some embodiments of the present disclosure, in order to improve accuracy of identification, the direction is left, right, top, bottom of the display screen;

step 304: determining whether content displayed on the display screen exceeds boundaries of the object currently displayed by the display;

step 305: when the content displayed on the display screen does not exceed boundaries of the object currently displayed by the display, computing a new position of a set point on the display screen in the display object coordinate system according to the movement data of the display; otherwise, entering step 307;

step 306: adjusting the region of the object currently displayed by the display which is displayed on the display screen so that the set point on the display screen reaches the new position, wherein a Graphics Processing Unit (GPU, graph processor) is used to process and output picture data information corresponding to the region; as shown in FIG. 4D, the display moves to the left relative to the initial position, and thus, the position of the display screen 401 relative to the display object 402 is adjusted to the left, the set point on the display screen reaches the new position, wherein the new position is located on the left of the original position of the set point on the display screen in the display object coordinate system.

step 307: when the content displayed on the display screen exceeds boundaries of the object currently displayed by the display, employing a set pattern display for the display content of boundaries of the object currently displayed by the display; as shown in FIG. 4B, the content displayed on the display screen 401 exceeds boundaries of the object 402 currently displayed by the display, and the content exceeding boundaries is displayed in black; in some embodiments of the present disclosure, in an arbitrary case where the content displayed on the display screen 401 exceeds boundaries of the object 402 currently displayed by the display, as shown in FIG. 4C, if the region displayed on the display is theoretically entirely a region which is outside boundaries of the display object 402 after adjusting the region of the object currently displayed by the display which is displayed on the display screen, a part of the display screen 401 displays the display object 402 and another part of the display screen 401 displays the set pattern.

Meanwhile, the present disclosure provides a display device for a display with a structure as shown in FIG. 5, the display device comprises:

a movement detection module 501 for detecting movement data of the display by a motion detection mechanism, wherein the movement data comprises at least a movement direction of the display;

a display region adjustment module 502 for changing a region of an object currently displayed by the display which is displayed on a display screen according to the movement data of the display.

In some embodiments of the present disclosure, still referring to FIG. 5, the device further comprises:

a display range detection module 500 for determining that the object currently displayed by the display exceeds a display range of the display screen.

In some embodiments of the present disclosure, the display range detection module comprises:

a size information acquisition unit for obtaining size information of the object currently displayed by the display;

a size information comparing unit for comparing the size information with size information of the display screen, and determining that the length of the object currently displayed by the display exceeds the length of the display screen or the width of the object currently displayed by the display exceeds the width of the display screen.

In some embodiments of the present disclosure, the device further comprises:

a coordinate establishing module for establishing a corresponding relationship between a coordinate system of the object currently displayed by the display and a coordinate system of the display screen.

In some embodiments of the present disclosure, the display region adjustment module comprises:

a position computation unit for computing a new position of a set point on the display screen in the object coordinate system according to the movement data of the display;

a position adjustment unit for adjusting the region of the object currently displayed by the display which is displayed on the display screen so that the set point on the display screen reaches the position.

In some embodiments of the present disclosure, the display region adjustment module further comprises:

a boundary processing unit for employing a set pattern display for the display content of boundaries of the object currently displayed by the display when content displayed on the display screen exceeds boundaries of the object currently displayed by the display.

In some embodiments of the present disclosure, the motion detection mechanism includes one or more of a gyroscope, a gravity sensor, an acceleration sensor, or a camera built in the display.

From the above description, it may be seen that, with respect to a picture which cannot be entirely presented by a display screen, the display method and the display device provided by the present disclosure can use the movement direction of the display as a signal indicator for switching the image displayed by the display screen. It achieves an effect that the whole image is browsed gradually by moving the cellphone laterally or longitudinally or diagonally. The operation of sliding the screen with a finger is omitted, and things are made easier.

It should be understood that a plurality of embodiments described in this specification are only for illustrating and explaining the present disclosure, and not to limit the present disclosure. And in a case where there is no conflict, embodiments in this application and features in embodiments may be combined with each other.

Obviously, those skilled in the art may make various changes and modifications to the present disclosure without departing from the spirit and the scope of the present disclosure. Thus, if these changes and modifications to the present disclosure are within the scope of claims of the present disclosure and equivalent technology, the present disclosure is also intended to encompass these changes and modifications.

1. A display method for a display, wherein the display method comprises the following steps:
detecting movement data of the display by a motion detection mechanism, wherein the movement data comprises at least a movement direction of the display; and
changing a region of an object currently displayed by the display which is displayed on a display screen according to the movement data of the display.

2. The display method according to claim 1, wherein before the step of detecting the movement data of the display by the motion detection mechanism, the display method further comprises: determining that the object currently displayed by the display exceeds a display range of the display screen.

3. The display method according to claim 2, wherein the step of determining that the object currently displayed by the display exceeds the display range of the display screen comprises:
obtaining size information of the object currently displayed by the display;
comparing said size information with size information of the display screen; and
determining that a length of the object currently displayed by the display exceeds the a length of the display screen or the a width of the object currently displayed by the display exceeds the width of the display screen.

4. The display method according to claim 2, wherein before the step of changing the region of the object currently displayed by the display which is displayed on the display screen according to the movement data of the display, the display method further comprises:
establishing a corresponding relationship between a coordinate system of the object currently displayed by the display and a coordinate system of the display screen.

5. The display method according to claim 4, wherein the step of changing the region of the object currently displayed by the display which is displayed on the display screen according to the movement data of the display comprises:
computing a new position of a set point on the display screen in the display object coordinate system according to the movement data of the display;
adjusting the region of the object currently displayed by the display which is displayed on the display screen so that the set point on the display screen reaches the new position; and
displaying display information of a display object region corresponding to the new position.

6. The display method according to claim 2, wherein the step of changing the region of the object currently displayed by the display which is displayed on the display screen according to the movement data of the display further comprises:
when content displayed on the display screen exceeds boundaries of the object currently displayed by the display, employing a set pattern display for display content of boundaries of the object currently displayed by the display.

7. The display method according to claim 1, wherein the motion detection mechanism includes one or more of a gyroscope, a gravity sensor, an acceleration sensor or a camera built in the display.

8. A display device for a display, wherein the display device comprises:
a movement detection module for detecting movement data of the display by a motion detection mechanism, wherein the movement data comprises at least a movement direction of the display; and
a display region adjustment module for changing a region of an object currently displayed by the display which is displayed on a display screen according to the movement data of the display.

9. The display device according to claim 8, wherein the display device further comprises:
a display range detection module for determining that the object currently displayed by the display exceeds a display range of the display screen.

10. The display device according to claim 9, wherein the display range detection module comprises:
a size information acquisition unit for obtaining size information of the object currently displayed by the display;
a size information comparing unit for comparing said size information with size information of the display screen, and determining that a length of the object currently displayed by the display exceeds a length of the display screen or the width of the object currently displayed by the display exceeds a width of the display screen.

11. The display device according to claim 9, wherein the display device further comprises:
a coordinate establishing module for establishing a corresponding relationship between a coordinate system of the object currently displayed by the display and a coordinate system of the display screen.

12. The display device according to claim 11, wherein the display region adjustment module comprises:
a position computation unit for computing a new position of a set point on the display screen in a display object coordinate system according to the movement data of the display;
a position adjustment unit for adjusting the region of the object currently displayed by the display which is displayed on the display screen so that the set point on the display screen reaches the new position, and displaying display information of a display object region corresponding to the new position.

13. The display device according to claim 9, wherein the display region adjustment module further comprises:
a boundary processing unit for employing a set pattern display for display content of boundaries of the object currently displayed by the display when content displayed on the display screen exceeds boundaries of the object currently displayed by the display.

14. The display device according to claim 8, wherein the motion detection mechanism includes one or more of a gyroscope, a gravity sensor, an acceleration sensor or a camera built in the display.
